(19) United States
(12) Patent Application Publication
(10) Pub. No.: US 2008/0246467 A1
(43) Pub. Date: Oct. 9, 2008

(54) Device For Counting the Rotations of an Object in a Referential, and Method For Controlling One Such Device

(76) Inventors: Franck Vial, Paladru (FR); Marc Beranger, Saint Martin D'Uriage (FR)

Correspondence Address: BRINKS HOFER GILSON & LIONE, P.O. BOX 10395, CHICAGO, IL, 60610, US

(21) Appl. No.: 11/994,242

(22) PCT Filed: Jun. 29, 2006
(86) PCT No.: PCT/FR2006/001520

§ 371 Date: Jan. 25, 2008

(30) Foreign Application Priority Data
Jul. 1, 2005 (FR) 0507055

(51) Int. Cl. G01B 7/30

(52) U.S. Cl. 324/207.25

(57) ABSTRACT

A device for counting rotations of an object in a referential, in which a magnetic sensor linked to the object measures a field associated with the referential in order to generate measuring signals at the rotational frequency of the object. The sensor also functions as an antenna for receiving an electromagnetic wave. A method for controlling a counting device includes receiving measurement signals and a radio-frequency triggering signal from a sensor and sending information representative of the numbering cycles in the measurement signals.

### PRIORITY CLAIM

This application is a U.S. nationalization of PCT Application No. PCT/FR2006/001520, filed Jun. 29, 2006, and claims priority to French Patent Application No. 0507055, filed Jul. 1, 2005.

### TECHNICAL FIELD

The invention concerns a device for counting rotations of an object in a frame of reference and a method of controlling such devices.

### BACKGROUND

There is known, for example from U.S. Pat. No. 3,353,487, the principle whereby the rotations of an object in the terrestrial magnetic field can be counted by placing a magnetic field sensor (for example a winding) on the object, the sensor therefore generating an alternating signal the number of cycles of which is representative of the number of rotations of the object.

In U.S. Pat. No. 3,353,487, this principle is applied to the measurement of the distance traveled by a projectile.

Since then, this principle has been applied to other fields, including the counting of the number of rotations of a tire, for example to monitor its state of wear.

One such application to tires is described in German Patent No. DE 101 17 920, for example.

In applications of this type, it is desirable to dispose the magnetic sensor within a stand-alone device that can be interrogated remotely when it is required to know the number of turns counted by the device at a given time.

To this end, the aforementioned German Patent No. DE 101 17 920 proposes that it be possible to trigger a data exchange procedure manually by moving a magnet toward the sensor.

This document even envisages sending low data rate data signals to the stand-alone device by means of frequency coding (examples of coding at 20 Hz or 30 Hz are mentioned) or amplitude coding.

Those solutions appear difficult to implement, however, because the data signals mentioned would inevitably run the risk of being confused with the magnetic field variations measured by the sensor as it rotates attached to the object in the terrestrial magnetic field.

This is probably why there is used more frequently in the literature the transmission of data by means of electromagnetic waves, often in the radio-frequency range (see for example U.S. Pat. No. 6,543,279), or even in the microwave domain (see for example U.S. Pat. No. 5,562,787).

### SUMMARY

In this context, the invention proposes a device for counting rotations of an object in a frame of reference, wherein a magnetic sensor connected to the object measures a field associated with the frame of reference in order to generate measurement signals at the rotation frequency of the object,

characterized in that the sensor also forms an antenna for receiving electromagnetic waves.

Thus the antenna forming sensor measures the magnetic field and at the same time receives radio-frequency signals, for example information for activating the controller of the device and/or triggering the sending of information obtained by counting to an external device.

The antenna forming sensor is produced by a coil, for example, in particular a winding comprising one turn or a plurality of turns. This solution is particularly practical.

The antenna forming sensor is coupled to radio-frequency signal receiver means, for example.

First filter means can then be disposed between the antenna forming sensor and the receiver means, for example to limit transmission to the receiver means to signals useful for this purpose.

To this end, the first filter means can in practice have a high impedance at the measurement frequencies of the sensor compared to their impedance for reception.

This prevents interference of the measurement signals in the receiver means.

The antenna forming sensor can also be coupled to means for counting cycles in the measurement signals.

Second filter means can then be disposed between the antenna forming sensor and the counting means, in particular to limit transmission to the counting means to measurement signals alone.

To this end, the second filter means can in practice have a high impedance at the reception frequencies of the antenna compared to their measurement impedance.

This prevents interference of the radio-frequency signals in the counting means.

The device can comprise means for sending numerical information obtained from the signals measured by the sensor, for example information linked directly or indirectly to the number of cycles in the signals measured.

An external device can in this way have access remotely to the number of rotations effected by the object.

The sending means can be configured, for example, to send said numerical information on reception of triggering information by the receiving antenna, which constitutes a beneficial dialog solution between the counting device and the external device.

The invention also proposes a method of controlling a device for counting rotations of an object in a frame of reference, characterized by the following steps:

reception of measurement signals at the rotation frequency of the object by means of a magnetic sensor linked to the object;

determination of the number of cycles in said measurement signals;

reception of a radio-frequency triggering signal by means of the magnetic sensor used as an electromagnetic antenna;

sending of information representative of said number of cycles.

### BRIEF DESCRIPTION OF THE DRAWING

Other features of the invention will become more apparent in the light of the following description, given with reference to the appended drawings, in which:

FIG. 1 represents the general schematic of a counting device according to the invention;

FIG. 2 represents a first portion of a detailed example of an electrical circuit for a counting device according to the invention;

FIG. 3 represents the overall behavior in the frequency domain of a portion of the circuit represented in FIG. 2; and

FIG. 4 represents a second portion of the detailed example from FIG. 2.

### DETAILED DESCRIPTION

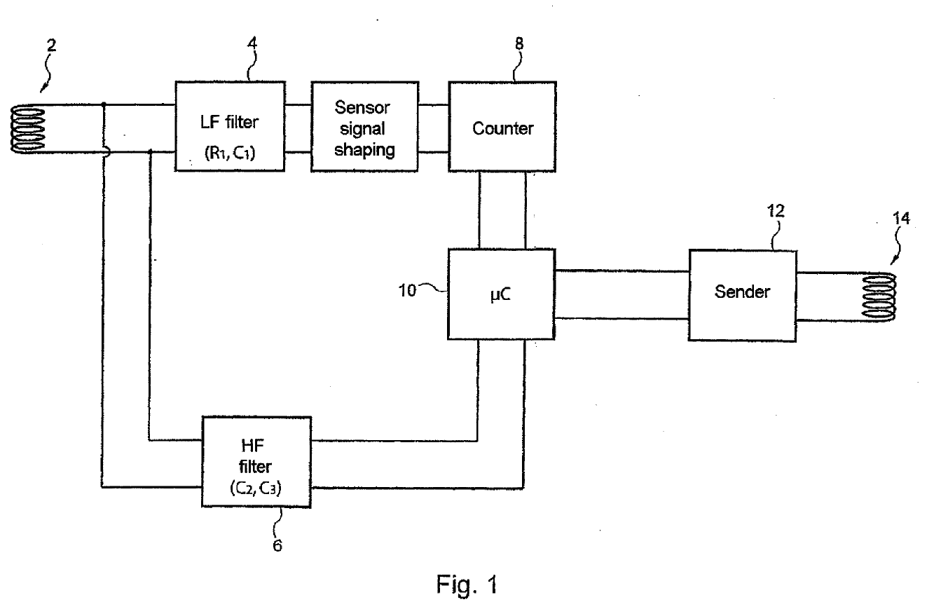

FIG. 1 represents the essential elements of a device conforming to the teachings of the invention for counting rotations of an object in a frame of reference.

This device is, for example, a stand-alone device mounted in a tire with the aim of counting the number of wheel rotations effected by the tire in order to obtain an indication as to its state of wear.

The counting device represented in FIG. 1 comprises a magnetic sensor 2 produced in practice by a coil, in particular a conductive winding formed of one turn or a plurality of turns.

The signal generated by the sensor 2 is transmitted on the one hand to a counter 8 through a low-frequency filter 4 (referred to hereinafter as the LF filter) and then where appropriate a signal shaping circuit, and on the other hand to receiver terminals of a microcontroller 10 through a high-frequency filter 6 as described in detail hereinafter.

The LF filter 4 is designed to transmit from the magnetic sensor 2 to the counter 8 only signals representative of the motion to be measured (in the illustrative embodiment the signals generated at the frequency of rotation of the object by the rotation of the magnetic sensor 2 in the terrestrial magnetic field).

To this end, the LF filter 4 has a high impedance outside the range of frequencies that corresponds to the measurement signals.

For example, in the in the illustrative embodiment of measuring rotations of a tire, given the typical rotation speeds of vehicle wheels, the signals generated by the rotation in the terrestrial magnetic field have frequencies varying between 1 Hz and a few tens of Hz.

In this case, the LF filter 4 has a high impedance from frequencies above 100 Hz, for example from 1 kHz.

The counter 8, which will be described in more detail hereinafter, has the function of counting the number of cycles in the signal generated by the magnetic sensor 2 because of its rotation in the terrestrial magnetic field, in particular in the signal transmitted by the LF filter 4.

For example, the counter 8 counts down a predetermined number of cycles (for example 4096 cycles) in the signal that it receives from the LF filter 4, then transmits an overshoot indication to a microcontroller 10 when the predetermined number is reached, and then resumes counting the predetermined number of cycles.

The microcontroller 10 increments an internal register each time overshoot information is received and thus stores the cumulative number of overshoot indications received, which thus represents (ignoring a multiplication factor) the number of cycles in the signal coming from the LF filter 4.

There is therefore easy access to the number of rotations of the counting device (and in equivalent manner of the magnetic sensor 2 that is attached to it) in the terrestrial magnetic field.

On this subject, PCT patent application No. WO 2004/110793 also describes certain of the aspects that have just been referred to.

As already indicated, the coil 2 is also connected to a high-frequency filter 6 (referred to hereinafter as the HF filter). This HF filter 6 is designed to have a high impedance in the frequency domains of the signals used for measurements (here for counting rotations), for example, the signals transmitted from the coil 2 to the counter 8 via the LF filter 4, so that the HF filter 6 transmits from the coil 2 to the receiver terminals of the microcontroller 10 only signals with frequencies above a given frequency (for example of the order of 1 kHz), or in a frequency band the lower limit of which corresponds to that given frequency.

The LF filter 4 and the HP filter 6 therefore have different pass-bands (for example on either side of 1 kHz), which enables transmission only of signals in a first frequency band to the counter 8 and only signals in a second frequency band from the coil 2 to the receiver terminals of the microcontroller 10.

In the second frequency band (here situated above 1 kHz, for example around 50 kHz with a pass-band of a few kHz, for example 5 kHz, which corresponds to a Q of 10), the coil 2 behaves as an electromagnetic antenna.

This enables reception of radio-frequency signals by the microcontroller 10 at its receiver terminals via the coil 2 and the HF filter 6.

Information can therefore be transmitted to the counting device (for example, microcontroller 10) by telecommunication by means of electromagnetic waves (for example on a 50 kHz carrier in the example referred to hereinabove).

It is a question in particular of activation information transmitted by an external device (typically a device of the electronic system of the vehicle or other device for monitoring the state of wear of the tires); this activation indication tells the counting device (microcontroller 10) that it must send information representative of the cumulative measured motion (in particular, the number of rotations effected) as described hereinafter.

To this end, the counting device illustrated in FIG. 1, also comprises a sender 12 electrically connected to the microcontroller 10 and a send antenna 14, for example also produced in the form of a conductive winding.

Thus, when microcontroller 10 receives activation information by means of the coil 2, serving as a reception electromagnetic antenna, but possibly also in other phases of its operation, the microcontroller 10 sends to the sender 12 information to be sent, such as the cumulative number of overshoot indications received, which as already indicated is representative of the number of rotations effected by the tire.

The sender 12 then converts this information (which it receives in the form of a bit stream, for example) into electrical signals to be sent in the form of an electronic wave by the send antenna 14, for example on a carrier at a send frequency, which has a value of 433.92 MHz in the embodiment described here.

To summarize, the microcontroller 10 receives measurement information generated by the coil 2 at the frequencies at which the latter behaves as a magnetic sensor (measurement information processed by the counter 8), and received information received via the coil 2 at frequencies in which it behaves as an electromagnetic antenna.

The LF filter 4 and the HF filter 6 limit transmission of signals to the counter and the receiver terminals of the microcontroller 10 to only the respective frequency ranges used in each case. In particular respective frequencies at which the measurement signals or information appear (generally below 100 Hz) and the radio-frequency signal receive frequencies, for example typically between 10 kHz and 1 MHz.

Thanks to this construction, the coil 2 plays simultaneously the roles of magnetic sensor and electromagnetic antenna, without this implying any problem for the operation of the circuit, such as any problems of interference between these two functions, for example.

One possible embodiment of a counting device according to the invention is described in detail below, the principal components of which have just been described with reference to FIG. 1.

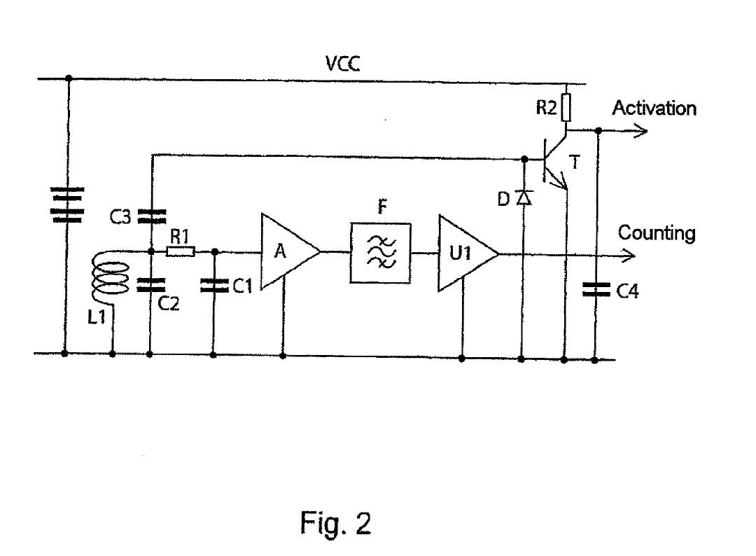

FIG. 2 represents a first portion of the electrical circuit of the counting device, which comprises in particular the coil 2, the LF filter 4 and the HF filter 6 from FIG. 1. As will be described hereinafter, the first portion of the electrical circuit represented in FIG. 2 performs functions other than those that have just been mentioned, and in particular shaping of the measurement signals as shown in FIG. 1.

The coil 2 is represented in the electrical circuit diagram of FIG. 2 by an inductor L1.

The coil 2 is produced by winding several thousand turns (for example between 1000 and 10 000 turns, here 3000 turns) each having an area of the order of 10 mm² and produced in insulated copper wire, which gives it an inductance of a few tens of mH. There is obtained in this way an equivalent area of the order of a few dm², or even a few tens of dm² (for example between 1 dm² and 1 m²).

The turns can advantageously be wound onto a core with high magnetic permeability, which produces an improvement in the sensitivity that corresponds to a multiplication of the equivalent area by a factor between 1 and 10, for example, here a factor of 6.

These dimensions of the coil enable it to constitute at low frequencies a magnetic sensor with a sensitivity of the order of 1 V/Tesla at 1 Hz, which therefore generates at its terminals a voltage of the order of 50 μV at 1 Hz when it rotates in the terrestrial magnetic field (taking for the latter a characteristic value of 50 μT).

The dimensions of the coil 2 also enable it, given its stray capacitance C_{stray}, which has a value of about 40 pF, to constitute an electromagnetic antenna sensitive in particular around its resonant frequency

$${f}_{o} = \frac{1}{2 Π} \sqrt{L 1 \cdot {C}_{stray}} ,$$

here about 100 kHz.

As can be seen in FIG. 2, the terminals of the coil 2 (represented by the inductor L1) are on the one hand connected by the series association of a resistor R1 and a capacitor C1 that form a low-pass filter F1 with a cut-off frequency 9 Hz. This low-pass filter F1 already transmits only measurement signals to the subsequent stages of the electronic circuit described hereinafter, even if other filters enhance this effect, as also explained hereinafter.

In fact, in the application considered here of measuring the number of rotations of the wheels of heavy goods vehicles (the maximum speed of which is of the order of 30 m/s and the circumference traveled by the sensor of the order of 3 m), the measured signals are below 10 Hz.

After filtering by the low-pass filter F1, the signals (at the terminals of the capacitor C1) are fed to a shaping stage comprising, for example, an amplifier A, a band-pass filter F and a comparator U1. The amplifier can have a gain of 100, for example.

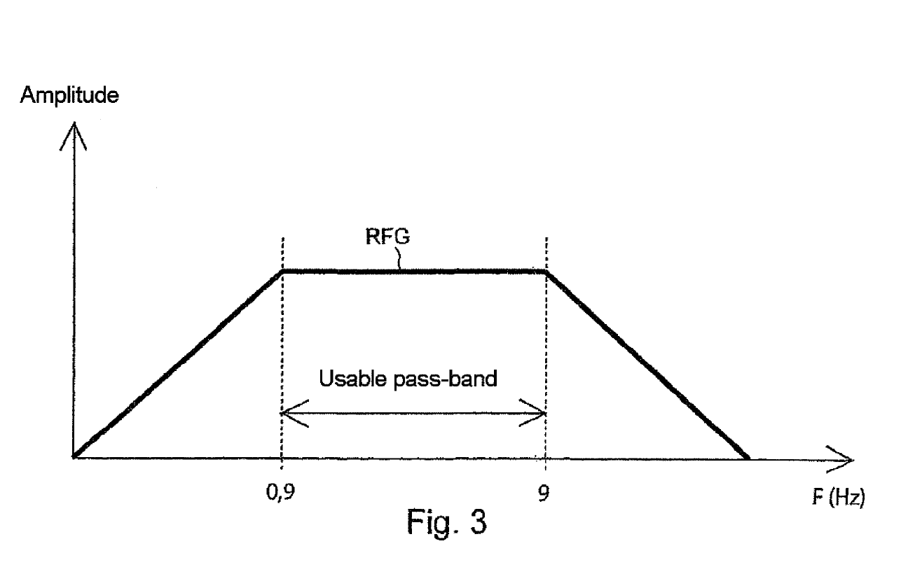

As clearly visible in FIG. 3, which represents the behavior in the frequency domain of all of the components that have just been described, the global frequency response RFG of the combination of the inductor L1, the low-pass filter F1 and the shaping stage is situated mainly between 0.9 Hz and 9 Hz, which constitutes the characteristic frequency range of the signals to be measured. (For a heavy goods vehicle, these frequencies correspond to speeds between about 10 km/h and 100 km/h.)

Note further that this overall frequency response RFG is essentially flat over this frequency range, which greatly simplifies the subsequent processing of the output signals generated.

The signals amplified by the amplifier A and transmitted by the band-pass filter P are applied to the comparator U1 which implements a function of detecting cycles of the signal generated by the coil 2 because of its rotation in the terrestrial magnetic field, after processing as described hereinabove. This comparator U1 thus generates counting pulses in correspondence with each of the cycles of the signal generated by the coil 2.

The circuit described hereinabove (and in particular the amplifier A) generates at the output of the band-pass filter F1 a signal for triggering the comparator; the latter then delivers a logic signal, for example with an amplitude of 3 V, compatible with digital circuits.

The terminals of the coil 2 (represented in the FIG. 2 circuit by the inductor L1) are connected on the other hand by means of a capacitor C2 (of 100 pF, for example) that lowers the resonant frequency of the coil 2 (which has a natural resonant frequency of the order of 100 kHz as indicated hereinabove) to around 50 kHz. Using the capacitor C2 also stabilizes the resonant frequency of the whole at this value of 50 kHz, the stray capacitance of the coil 2 (approximately 40 pF, see above) in practice ruling out obtaining a sufficiently stable value of the resonant frequency.

The signal at the terminals of the combination of the inductor L1 and the capacitor C2 is transmitted to a transistor T via a capacitor C3 that allows to pass in the direction of the transistor T only signals at frequencies higher than a particular value. The capacitor C3 therefore forms a high-pass filter with a lower cut-off frequency of 50 kHz here, which forms the HF filter from FIG. 1.

Thus when the peak amplitude of the high-frequency signals (here at 50 kHz) at the terminals of the coil exceeds 0.6 V (thanks to the amplification generated naturally by the resonance of the whole at this frequency), the transistor T conducts and its emitter-collector voltage changes from 3 V to 0 V, which constitutes an activation indication transmitted to the microcontroller 10 as described hereinafter.

The counting device is supplied with power by an electrical cell delivering a voltage VCC of 3 V, for example a BR1632A cell.

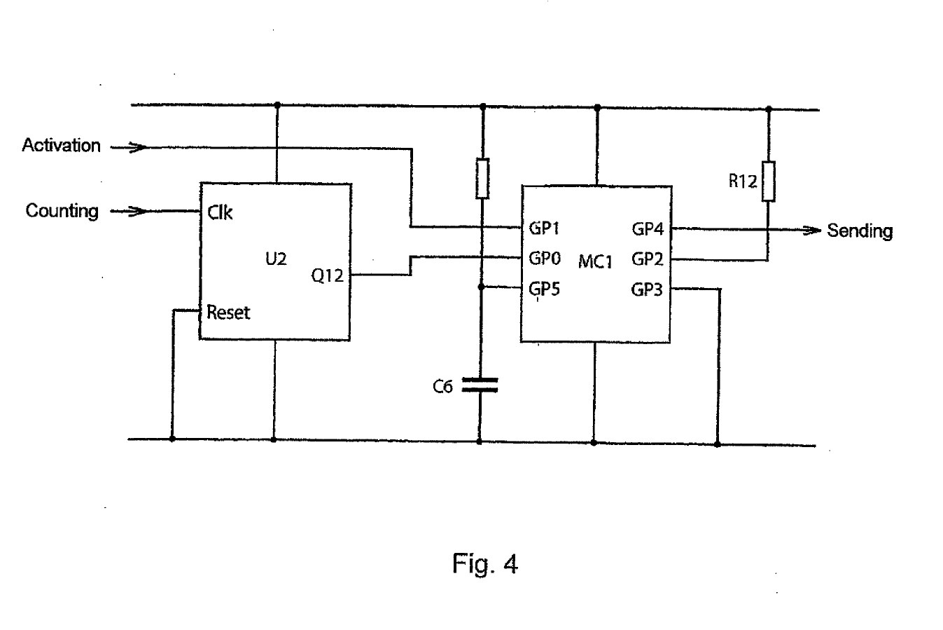

A second portion of the electrical circuit of the counting device is represented in FIG. 4.

The counting information sent by the comparator U1 (after low-pass filtering and processing of the signals from the coil 2) in the form of a logic signal is fed to the clock input terminal (“Clk”) of a divider circuit U2 produced in HC.MOS technology, for example, such as 74HC4040 circuit.

The output Q12 of this divider is used, for example, at which a change of state is generated after reception of 2¹² rising (or falling) counting edges at the clock input, for example every 4096 edges (which represent 4096 turns of the wheel of the vehicle).

The signal delivered by the output Q12 (referred to hereinabove as the overshoot indication) is applied to a terminal GPO of the microcontroller 10 (referenced MC1 in FIG. 4), which, as already explained, activates the microcontroller and increments an internal register thereof that stores the cumulative number of overshoots received.

The microcontroller 10 (or MC1 in FIG. 4, for example a PIC12C509 produced by MICROCHIP) receives at a second terminal GP1 the activation indication formed by the transistor T when the antenna formed by the coil 2 receives a signal at 50 kHz and transmits it to the transistor T via the high-pass filter (or HF filter) consisting of the capacitor C3.

As already explained in general terms hereinabove, on reception of this activation pulse, the microcontroller MC1 sends at a third terminal GP4 information to be sent, for example in the form of a “Manchester” coded frame, that contains in particular the cumulative number of overshoot indications received as stored in the internal register of the microcontroller 10 as indicated hereinabove.

The frame (or information to be sent) is fed as already indicated to the input of a sender, for example a sender available off the shelf: AUREL: TX-SAW I.A, RF solutions: AM-TX1-433, or QUASAR: A.M.-QAMT2.

The embodiment that has just been described, and in particular the numerical values indicated, constitute only one possible example of implementation of the invention.

1. A device for counting rotations of an object in a frame of reference, wherein a magnetic sensor connected to the object measures a field associated with the frame of reference in order to generate measurement signals at the rotation frequency of the object,
wherein the sensor also operates as an antenna for receiving electromagnetic waves.

2. The device according to claim 1, wherein the sensor comprises a coil.

3. The device according to claim 1, wherein the sensor is coupled to radio-frequency signal receiver means.

4. The device according to claim 1, further comprising first filter means disposed between the sensor and the receiver means.

5. The device according to claim 1, wherein the first filter means has a high impedance at the measurement frequencies of the sensor relative to their impedance for reception.

6. The device according to claim 1, wherein the sensor is coupled to counting means for counting cycles in the measurement signals.

7. The device according to claim 6, further comprising second filter means disposed between the sensor and the counting means.

8. The device according to claim 7, wherein the second filter means have a high impedance at the reception frequencies of the antenna relative to their measurement impedance.

9. The device according to claim 8, further comprising sender means for sending numerical information obtained from the measurement signals generated by the sensor.

10. The device according to claim 9, wherein the sender means are configured to send the numerical information on reception of triggering information by means of the receiving antenna.

11. A method of controlling a device for counting rotations of an object in a frame of reference, comprising the following steps;
receiving measurement signals at the rotation frequency of the object by means of a magnetic sensor linked to the object;
determining the number of cycles in said the measurement signals;
receiving a radio-frequency triggering signal by means of the magnetic sensor operating as an electromagnetic antenna; and
sending information representative of the number of cycles.
